(19) United States
(12) Patent Application Publication
(10) Pub. No.: US 2020/0183624 A1
(43) Pub. Date: Jun. 11, 2020

(54) FLEXIBLE RAID DRIVE GROUPING BASED ON PERFORMANCE

(71) Applicant: EXTEN Technologies, Inc., Austin, TX (US)

(72) Inventor: Michael J. Enz, Fargo, ND (US)

(21) Appl. No.: 16/703,617

(22) Filed: Dec. 4, 2019

Related U.S. Application Data
(60) Provisional application No. 62/775,702, filed on Dec. 5, 2018.
(60) Provisional application No. 62/775,706, filed on Dec. 5, 2018.

(51) Int. Cl. G06F 3/06; G06F 11/10; G06F 11/34

(52) U.S. Cl. CPC G06F 3/0689; G06F 3/0604; G06F 11/3409; G06F 3/0659; G06F 11/1076; G06F 3/0653

(57) ABSTRACT

Systems and methods for RAID data storage in which data is written across a subset of the RAID drives, where the subset is selected based on drive performance. For instance, if a write will use N−2 of a total of N drives, the system may be configured to determine the two most heavily loaded drives (e.g., based on the respective weighted queue depths of the drives), and may exclude these drives from the write. The data may then be written to the remaining N−2 drives. The system may be configured to determine the RAID encoding for each write request independently of other writes, so the number of drives which are excluded may vary between write requests.

### RELATED APPLICATIONS

This application claims the benefit of priority under 35 U.S.C. § 119(e) to U.S. Provisional Patent Application No. 62/775,702 filed on Dec. 5, 2018, by inventor Michael Enz entitled “Flexible Raid Drive Grouping Based on Performance”, and claims the benefit of priority under 35 U.S.C. § 119(e) to U.S. Provisional Patent Application No. 62/775,706 filed on Dec. 5, 2018, by inventor Ashwin Kamath entitled “Extent Based Raid Encoding”, the entire contents of which are hereby fully incorporated by reference herein for all purposes.

### TECHNICAL FIELD

This disclosure relates generally to the field of data storage, and more particularly to systems and methods for encoding data across a set of RAID drives using a flexible grouping to increase performance.

### BACKGROUND

Data represents a significant asset for many entities. Consequently, data loss, whether accidental or caused by malicious activity, can be costly in terms of wasted manpower, loss of goodwill from customers, loss of time and potential legal liability. To ensure proper protection of data, it may be possible to implement a variety of techniques for data storage that provide redundancy or performance advantages. In some cases, storage systems allow data to be safely stored even when the data storage system experiences hardware failures such as the failure of one of the disks on which the data is stored. In some cases, storage systems may be configured to improve the throughput of host computing devices.

One technique used in some data storage systems is to implement a Redundant Array of Independent Disks (RAID). Generally, RAID systems store data across multiple hard disk drives or other types of storage media in a redundant fashion to increase reliability of data stored by a computing device (which may be referred to as a host). The RAID storage system provides a fault tolerance scheme which allows data stored on the hard disk drives (which may be collectively referred to as a RAID array) by the host to survive failure of one or more of the disks in the RAID array.

To a host, a RAID array may appear as one or more monolithic storage areas. When a host communicates with the RAID system (e.g., reads from the system, writes to the system, etc.) the host communicates as if the RAID array were a single disk. The RAID system processes these communications in a way that implements a certain RAID level. These RAID levels may be designed to achieve some desired balance between a variety of tradeoffs such as reliability, capacity, speed, etc.

For example, RAID level 0 (which may simply be referred to as RAID 0) distributes data across several disks in a way which gives improved speed and utilizes substantially the full capacity of the disks, but if one of these disks fails, all data on that disk will be lost. RAID level 1 uses two or more disks, each of which stores the same data (sometimes referred to as “mirroring” the data on the disks). In the event that one of the disks fails, the data is not lost because it is still stored on a surviving disk. The total capacity of the array is substantially the capacity of a single disk. RAID level 5 distributes data and parity information across three or more disks in a way that protects data against the loss of any one of the disks. In RAID 5, the storage capacity of the array is reduced by one disk (for example, if N disks are used, the capacity is approximately the total capacity of N−1 disks).

One problem with typical RAID parity designs is that write performance must be perfectly balanced on all drives. In the case of sequential IO, each drive will perform precisely the same number of writes. To encode a RAID level 5 stripe, the software must write N drives plus 1 parity drive. Each of those N+1 drives will have to provide the same data write rate for the RAID IO, but this may not be possible due to varying loads on the individual drives resulting from random user reads and variability in NAND programming and erase times. As one drive slows down because of a heavier load, it will cause writes on all of the drives involved in the RAID IO to slow down equivalently.

### SUMMARY

The present systems and methods are intended to reduce or eliminate one or more of the problems of conventional RAID systems by enabling the storage of data in less than all of the storage drives in the system, where the drives that are used for a particular write request (which may be less than all of the drives in the system) are determined based at least in part on performance metrics, such as the loading of the individual drives. The drive loading may be determined by, for example, examining the pending reads and writes for each drive and determining a queue depth. The reads and writes may each be weighted by a corresponding factor that takes into account the different costs associated with reads and writes. The weighted pending reads and writes are summed for each drive to determine the loading for that drive. Then, the drives that are most heavily loaded can be eliminated from consideration for a write request, and the write can proceed with a selected RAID encoding using a set of drives that are less heavily loaded. Consequently, the write is not delayed by the need to involve a heavily loaded drive.

One embodiment comprises a system for data storage having a plurality of RAID storage drives and a storage engine coupled to the drives. The storage engine in this embodiment is configured to receive write requests from a user to write data on the storage drives. For each of the write requests, the storage engine is configured to determine a corresponding RAID encoding and to determine a number, M, of the storage drives that are required for the RAID encoding, where M is less than a total number, N, of the storage drives. The storage engine is configured to determine the expected performance for one or more of the plurality of storage drives, such as by determining the depth of a queue for IO accesses to the storage drives. Based at least in part on the expected performance for the drives, the storage engine selects a set of M drives and writes the data corresponding to the write request to the selected set of M drives using the selected RAID encoding.

In one embodiment, the storage engine is configured to determine the expected performance by determining the number of pending reads and writes that are in queue for each of the N storage drives in the system, weight the reads and writes (to account for the different costs of reads and writes), and sum the weighted reads and writes to produce a loading value for each drive. Based on these loading values, the storage engine may exclude the most highly loaded drives and then select the M drives to be used for each write request from the remaining storage drives. Different write requests may be written to different sets of storage drives (e.g., each may use a different number, M, of drives, or they may use the same number, M, of drives, but may use a different set of M drives). The RAID encoding corresponding to each write request may be selected based on a service level indicated by the user, which may include a redundancy level or an access speed), or it may be based on the availability of storage drives to service the request. The storage engine is configured to maintain a metadata tree to store metadata for the write data. In one embodiment, the metadata tree includes multiple entries, where each entry has a user address and data length for the key and has drive addresses at which the data is written on the storage drives, as well as a RAID encoding with which the data is written to the drives.

An alternative embodiment comprises a system for RAID data storage that has a plurality of storage drives and a storage engine coupled to the storage drives to receive and process requests to write data the plurality of storage drives. In this embodiment, the storage engine is configured to determine the expected performance for each of the plurality of storage drives, determine a number of the drives that have an acceptable level of expected performance (e.g., as determined by IO queue depth), and then determine a corresponding RAID encoding based at least in part on the number of drives that have the acceptable level of expected performance. For example, if there are five drives that have acceptable expected performance, then data might be written across four disks with parity information written to one. If, on the other hand, there are only four drives that have acceptable expected performance, then data might be written across three disks with parity information written to one. If there are more drives with acceptable expected performance available, a subset of these drives may be selected for a write using a selected RAID encoding. The RAID encoding for each write request may be based in part on a service level indicated by the user, wherein the service level includes a redundancy level and/or a data access speed. The RAID encoding may be stored in a metadata tree that includes a user address and a data length as a key, and includes physical drive address(es) and the RAID encoding as a value associated with the key.

Another alternative embodiment comprises a method for RAID data storage. This method includes receiving requests to write data on one or more of a plurality of storage drives. For at least some of the write requests, the method further includes determining a corresponding RAID encoding, determining a number of the drives required for the corresponding RAID encoding, determining the expected performance of the drives, selecting a subset of the drives based at least in part on their expected performance, and writing data to the selected subset of drives using the corresponding RAID encoding.

In some embodiments, the expected performance is determined using a queue depth for each of the storage drives, such as by taking a weighted sum of the pending reads and writes for each drive. The subset of storage drives to be used for a write may be determined by excluding one or more of the drives which have the lowest expected performance and selecting the required number of drives from the remainder of the drives. The drives selected for one write may be different from the drives selected for another write. The RAID encoding for each write request may be selected based in part on a service level indicated by the user, wherein the service level may include a redundancy level or a data access speed. The method may include maintaining a metadata tree in which each write request has a corresponding entry in the table. The key of the entry may include the user address and a data length, while the value of the entry may include the corresponding physical addresses at which data is written on the selected set of drives, as well as the RAID encoding for the write.

Numerous other embodiments are also possible.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a diagram illustrating a multi-core, multi-socket server with a set of NVME solid state drives in accordance with one embodiment.

FIGS. 2A and 2B are diagrams illustrating the striping of data across multiple drives using conventional RAID encodings.

FIGS. 3A and 3B are diagrams illustrating the contents of metadata table structures for user volumes using conventional RAID encodings as illustrated in FIGS. 2A and 2B.

FIGS. 4-6 are diagrams illustrating the loading of drives in the storage system and the exclusion of the most heavily loaded drives in accordance with one embodiment.

FIG. 7 is a diagram illustrating an example of a write IO an exemplary system in accordance with one embodiment.

FIG. 8 is a diagram illustrating metadata that is stored in a metadata tree in accordance with one embodiment.

FIG. 9 is a diagram illustrating a tree structure that is used to store metadata in accordance with one embodiment.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As noted above, data is a significant asset for many entities, and it is important for these entities to be able to prevent the loss of this asset. Conventional RAID data storage systems provide a useful tool to combat data loss, but these systems may still have problems that impact the performance of data accesses. For example, if one of the drives in a conventional RAID system has a higher load than the other drives, there may be delays in the accesses to the highly loaded drive. Since accesses to the RAID system are limited by the lowest performing drive, this may significantly reduce the performance of the whole system, even if the other drives are performing optimally.

This problem is addressed in embodiments of the present invention by providing a RAID data storage system in which data is written across a subset of the RAID drives. For instance, if the system has six drives, the system may be configured to write the data for a given request across only four of the drives. When the write request is received by the RAID storage system, the load associated with each of the drives may be examined to determine which of the drives are most heavily loaded. The system may, for example, use the queue depth of each drive as an indicator of the loading on that drive. In this example, the system would exclude the two most heavily loaded drives, and would write the RAID encoded data across the remaining four drives. As a result, the loading on the two excluded drives would not negatively impact the performance of the write across the remaining four drives.

In some embodiments, each write request specifies an “extent” which identifies a user address and a length of the data to be written. The data storage system determines an encoding for the data based on the length of the data to be written and the performance requirements of the user (e.g., redundancy and access speed). The encoding of each data write may be determined independently of other writes. The system then determines the number of required drives and writes the data across the least loaded drives. The data may be remapped so that it is not written with the same offset on each drive.

RAID data storage techniques as disclosed herein may be implemented in a variety of different storage systems that use various types of drives and system architectures. One particular data storage system is described below as a nonlimiting example. The techniques described here work with any type, capacity or speed of drive, and can be used in data storage systems that have any suitable structure or topology.

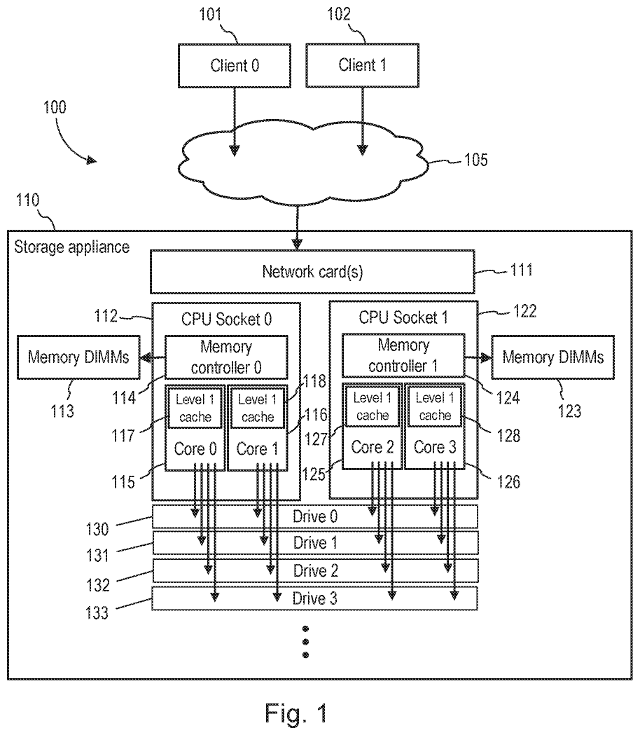

Referring to FIG. 1, an exemplary RAID data storage appliance in accordance with one embodiment is shown. In this embodiment, a multi-core, multi-socket server with a set of non-volatile memory express (NVME) solid state drives is illustrated. In exemplary system 100, multiple client computers 101, 102, etc., are connected to a storage appliance 110 via a network 105. The network 105 may use an RDMA protocol, such as, for example, ROCE, iWARP, or Infiniband. Network card(s) 111 may interconnect the network 105 with the storage appliance 110.

Storage appliance 110 may have one or more physical CPU sockets 112, 122. Each socket 112, 122 may contain its own dedicated memory controller 114, 124 connected to dual in-line memory modules (DIMM) 113, 123, and multiple independent CPU cores 115, 116, 125, 126 for executing code. The CPU cores may implement a storage engine that acts in conjunction with the appliance's storage drives to provide the functionality described herein. The DIMM may be, for example, random-access memory (RAM). Each core 115, 116, 125, 126 contains a dedicated Level 1 (L1) cache 117, 118, 127, 128 for instructions and data. Each core 115, 116, 125, 126 may use a dedicated interface (submission queue) on a NVME drive.

Storage appliance 110 includes a set of drives 130, 131, 132, 133. These drives may implement data storage using RAID techniques. Cores 115, 116, 125, 126 implement RAID techniques using the set of drives 130, 131, 132, 133. In communicating with the drives using these RAID techniques, the same N sectors from each drive are grouped together in a stripe. Each drive 130, 131, 132, 133 in the stripe contains a single “strip” of N data sectors. Depending upon the RAID level that is implemented, a stripe may contain mirrored copies of data (RAID1), data plus parity information (RAIDS), data plus dual parity (RAID6), or other combinations. It would be understood by one having ordinary skill in the art how to implement the present technique with all RAID configurations and technologies.

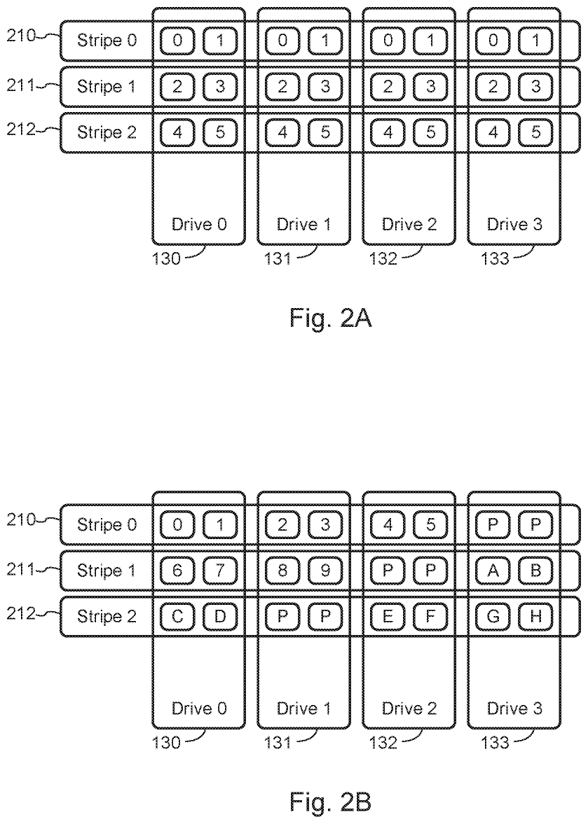

The present embodiments implement RAID techniques in a novel way that is not contemplated in conventional techniques. It will therefore be useful to describe examples of the conventional techniques. In each of these conventional techniques, the data is written to the drives in stripes, where a particular stripe is written to the same address of each drive. Thus, as shown in FIGS. 2A and 2B, Stripe 0 (210) is written at a first address in each of drives 130, 131, 132, 133, Stripe 1 (211) is written at a second address in each of the drives, and Stripe 2 (212) is written at a third address in each of the drives.

Referring to FIG. 2A, a conventional implementation of RAID level 1, or data mirroring, using the system of FIG. 1 is illustrated. In this example, six sectors of data (0-5) are written to the drives 130, 131, 132, 133. The data is mirrored to each of the drives. That is, the exact same data is written to each of the drives. Each of the drives has a strip size of N=2, so two sectors of data can be written to each drive in each stripe. As shown in the figure, for each drive, sectors 0 and 1 are written in stripe 0, sectors 2 and 3 are written in stripe 1, and sectors 4 and 5 are written in stripe 2. If a write is made to one of these sectors, it is necessary to write to the same sector on each of the drives.

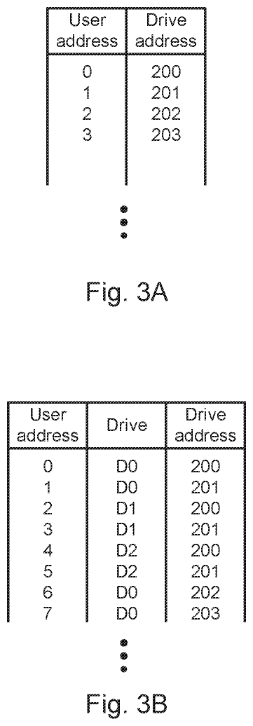

Referring to FIG. 3A, a diagram illustrating the contents of a metadata table structure for the user volume depicted by FIG. 2A is shown. This figure depicts a simple table in which the user volume address and offset of the stored data is recorded. For example, sectors 0 and 1 are stored at an offset of 200. Sectors 2 and 3 are stored at an offset of 202. Because the data is mirrored on each of the drives, it is not necessary to specify the drive on which the data is stored. This metadata may alternatively be compressed to:
User Volume V
Starting offset: 200
Drives: D0, D1, D2, D3
Encoding: RAID1
Strip size: 2

Referring to FIG. 2B, a conventional implementation of RAID level 5 is shown. Again, Stripe 0 (210) is written at a first address in each of drives 130, 131, 132, 133, Stripe 1 (211) is written at a second address in each of the drives, and Stripe 2 (212) is written at a third address in each of the drives. Also as in the example of FIG. 2A, the strip of each drive corresponding to Stripe 0 contains two sectors.

In a RAID 5 implementation, the system does not write the same data to each of the drives. Instead, different data is written to each of the drives, with one of the drives storing parity information. Thus, for example, Stripe 0 contains sectors 0-5 of data (stored on drives 130, 131, 132), plus two sectors of parity (stored on drive 133). The parity information for different stripes may be stored on different ones of the drives. If any one of the drives fails, the data (or parity information) that was stored on the failed drive can be reconstructed from the data and/or parity information stored on the remaining three drives.

Referring to FIG. 3B, a diagram illustrating the contents of a metadata table structure for the user volume depicted by FIG. 2B is shown. This figure depicts a simple table in which the user volume address, drive and offset of the stored data is recorded. In this example, sectors 0 and 1 are stored on Drive 0 at an offset of 200. Sectors 2 and 3, which are stored in the same stripe as sectors 0 and 1 are stored on Drive 1 at an offset of 200. This metadata may alternatively be compressed to:
User Volume V
Starting offset: 200
Drives: D0, D1, D2, D3
Encoding: RAIDS
Strip size: 2

If data is written to one of the stored sectors on a RAID 5 system, the corresponding parity information must also be written. Consequently, a small random IO (data access) on this system requires reading both the old data and old parity to compute the updated parity. For RAID 5, that translates a single sector user's write into 2 read sectors (old data and old parity) and 2 writes (new data and new parity).

The traditional RAID systems illustrated in FIGS. 2A and 2B encode parity information across an entire set of drives, where the user's data address implicitly determines which drive will hold the data. This is a type of direct mapping—the user's data address can be passed through a function to compute the drive and drive address for the corresponding sector of data. As the RAID system encodes redundant information, sequential data sectors will be striped across the drives to achieve redundancy (e.g., through the use of mirroring or parity information). The data is written to all of the RAID drives. For instance, if there are four drives, data that is written to the RAID storage system will be striped across all four drives.

Some software systems can perform address remapping, which allows a data region to be remapped to any drive location by using a lookup table (instead of a mathematical functional relationship). Address remapping requires metadata to track the location (e.g., drive and drive address) of each sector of data, so the compressed representation noted above for sequential writes as in the examples of FIGS. 2 and 3 cannot be used. The type of system that performs address remapping is typically still constrained to encode data on a fixed number of drives. Consequently, while the address or location of the data may be flexible, the number of drives that are used to encode the data (four in the examples of FIGS. 2A and 2B) is not.

One of the advantages of being able to perform address remapping is that multiple write IOs that are pending together can be placed sequentially on the drives. As a result, a series of back-to-back small, random IOs can “appear” like a single large IO for the RAID encoding, in that the system can compute parity from the new data without having to read the previous parity information. This can provide a tremendous performance boost in the RAID encoding.

In the present embodiments, writes to the drives do not have the same constraints as in conventional RAID implementations as illustrated in FIGS. 2A and 2B. Rather than striping data across all of the drives at the same address on each drive, each user write can be written across less than all of the drives. In one embodiment, each user write is indicates an “extent” which, for the purposes of this disclosure, is defined as an address and a length of data. The address is the address in the user volume, and the length is the length of the data being written (typically a number of sectors). The data is not necessarily written to a fixed number of drives, and Instead of being striped across the same location of each of the drives, the data may be written to different locations on each different drive. One embodiment of the present invention also differs from conventional RAID implementations in that each user write is encoded with an appropriate redundancy level, where each write may potentially use a different RAID encoding algorithm, depending on the write size and the service level definition for the write.

Embodiments of the present invention move from traditional RAID techniques which are implementation-centric (where the implementation constrains the user) to a customer-centric techniques, where each user has the flexibility to define the service level (e.g., redundancy and access speed) for RAID data storage. The redundancy can be defined to protect the data against a specific number of drive failures, which typically is 0 to 2 drive failures, but may be greater. The method by which the redundancy is achieved is often irrelevant to the user, and is better left to the storage system to determine. This is a significant change from legacy systems, which have pushed this requirement up to the user. In embodiments disclosed herein, the user designates a service level for a storage volume, and the storage system determines the most efficient type of RAID encoding for the desired service level and encodes the data in a corresponding manner.

The service level may be defined in different ways in different embodiments. In one exemplary embodiment, it includes redundancy and access speed. The redundancy level determines how many drive failures must be handled. For instance, the data may have no redundancy (in which case a single drive failure may result in a loss of data), single redundancy (in which case a single drive failure can be tolerated without loss of data), or greater redundancy (in which case multiple drive failures can be tolerated without loss of data). Rather than being constrained to use the same encoding scheme and number of drives for all writes, the system may use any encoding scheme to achieve the desired level of redundancy (or better). For example, the system may determine that the data should be mirrored to a selected number of drives, it may parity encode the data for single drive redundancy, it may Galois field encode the data for dual drive redundancy, or it may implement higher levels of erasure encoding for still more redundancy.

As noted above, the service level in this embodiment also involves data access speed. Since data can be read from different drives in parallel, the data access rates from the drives are cumulative. For example, the user may specify that IO read access of at least 1 GB/s is desired. If each drive can support IO reads at 500 MB/s, then it would be necessary to stripe the data across at least two of the drives to enable the desired access speed ((1 GB/s)/(500 MB/s)=2 drives). If IO read access of at least 2 GB/s is desired, the data would need to be striped across four 500 MB/s drives.

Based on the desired redundancy and access speed for a particular user, the storage system can determine the appropriate encoding and drive count that are needed for that user. It should be noted that the performance metric (access speed) can also influence the encoding scheme. As indicated above, performance tends to increase by using more drives. Therefore, the system may perform mirrored writes to 2 drives for one level of performance, or 3 drives for the next higher level of performance. In the second case (using 3 mirrored copies), meeting the performance requirement may cause the redundancy requirement to be exceeded.

In another example, the system can choose a stripe size for encoding parity information based on the performance metric. For instance, a large IO can be equivalently encoded with a 4+1 drive parity scheme (data on four drives and parity information on one drive), writing two sectors per drive, or as a 8+1 parity encoding writing one sector per drive. By defining the service level in terms of redundancy and access speed, the storage system is allowed to determine the best RAID technique for encoding the data.

After the drive count has been determined, the particular drives that are to be used for the write IO are determined. When selecting the set of drives for encoding the user IO and redundancy data, a naïve solution would use a round robin algorithm to data and parity across all available drives. While this works to balance the write capacity on all drives, it does not address the possibility that the loading of the drives is uneven, and that the performance of the system may be reduced because this uneven loading may have slowed down one of the drives.

In one embodiment, the storage system determines the expected drive performance and uses this to select the drives to be used for the write IO. For example, the storage system may examine the current backlog of work pending for each drive (which is commonly referred to as the drive's IO queue depth), including any write or read commands. Based on the work backlog, the system identifies a set of drives to use for the encoding of the IO write data. A key factor in determining which drives are selected is that the most heavily loaded drive or drives should be avoided. The remaining drives may then be used for data and redundancy encoding.

In some cases, the number of drives that are available after excluding the most heavily loaded drive(s) may influence the selection of the encoding algorithm. For instance, if there are five drives that are not heavily loaded, a parity encoding of 4 data regions plus 1 parity region may be implemented across the five drives. Alternatively, if only four drives are not heavily loaded, an encoding of three data regions plus one parity region may be implemented across the four selected drives. By selecting drives that are not heavily loaded, this method helps to maximize the throughput of the storage system, and particularly to achieve maximum bandwidth at the drive layer.

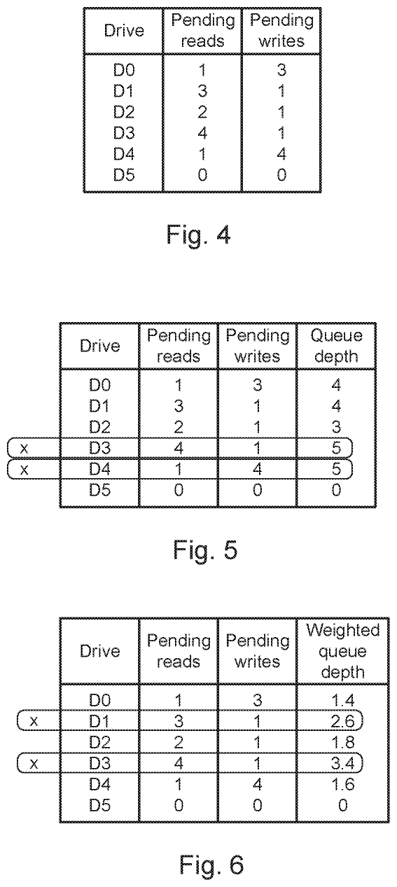

Referring to FIGS. 4-6, some examples are provided to illustrate the selection of a set of drives to be used in a RAID write IO. In these examples, the data storage system has six drives (D0-D5) that are available for use. Other embodiments may have more or fewer drives that are available. When this system receives a write IO request, the system identifies the service level for the request and determines a number of drives that are required for the IO. It is assumed for the purposes of this example that four drives are needed, although the number may vary from one write IO to another. The system examines the drives to determine the number of pending reads and writes for each of the drives. An example of the numbers of pending reads and writes is shown in FIG. 4.

In one embodiment, the numbers of reads and writes are simply added together to produce a total queue depth for each drive. This is shown in FIG. 5. It can be seen that drives D0 and D1 each have four pending IOs, drive D2 has three, drives D3 and D4 each have five, and drive D5 has none.

Since only four of the six drives are needed for the new write IO, two of the drives can be excluded. The storage system in this embodiment simply excludes the drives that have the greatest number of pending IOs. In this example, the greatest queue depth is five—each of drives D3 and D4 has five pending IOs. Drives D3 and D4 are therefore excluded (as indicated by the “x” next to each of these drives in the figure). The remaining drives—D0-D2 and D5—would then be used for the new write IO.

In an alternative embodiment, the read IOs could be weighted differently from the write IOs in order to account for differences in the loading resulting from reads and writes. For example, since reads are more costly than writes, the reads may be weighted by a factor of 0.8, while the writes are weighted by a factor of 0.2. The resulting weighted queue depth is shown in FIG. 6. In this case, drives D1 and D3 are considered to be the most heavily loaded, so they are excluded from being selected for the new write IO (as indicated by the “x” next to each of these drives). Drives D0, D2, D4 and D5 are therefore used for the write IO.

In one embodiment, the system has enough drives to allow at least two drives to be excluded for each write IO. Thus, for example, a system with ten drives would have eight available for each write IO. It should be noted that a given write IO need not use all of the available drives. It should also be noted that drives may be excluded for other reasons, such as having insufficient capacity to store the data that would be required for a particular write IO.

Each IO is remapped as an extent by also writing metadata. Writing metadata for an IO uses standard algorithms in filesystem design, and therefore will not be discussed in detail here. To be clear, although there are existing algorithms for writing metadata generally, these algorithms conventionally do not involve recording an extent associated with RAID storage techniques.

The remapping metadata in the present embodiments functions in a manner similar to a filesystem ‘inode’, where the filename is replaced with a numeric address and length for block based storage as described in this disclosure. Effectively, the user's address (the address of the IO in the user's volume of the storage system) and length (the number of sectors to be written) are used as a key (instead of filename) to lookup the associated metadata. The metadata may, for example, include a list of each drive and the corresponding address on the drive where the data is stored. It should be noted that, in contrast to conventional RAID implementations, this address may not be the same for each drive. The metadata may also include the redundancy algorithm that was used to encode the data (e.g., RAID 0, RAID 1, RAID 5, etc.) The metadata may be compressed in size by any suitable means.

The metadata provides the ability to access the user's data, the redundancy data, and the encoding algorithm. The metadata must be accessed when the user wants to read back the data. This implies that metadata is stored in a sorted data structure based on the extent (address plus length) key. The data structure is typically a tree structure, such as a B+TREE, that may be cached in RAM and saved to a drive for persistence. This metadata handling (but not the use of the extent key) is well-understood in file system design. It is also understood that data structures (trees, tables, etc.) other than a B+TREE may be used in various alternative embodiments. These data structures for the metadata may be collectively referred to herein as a metadata tree.

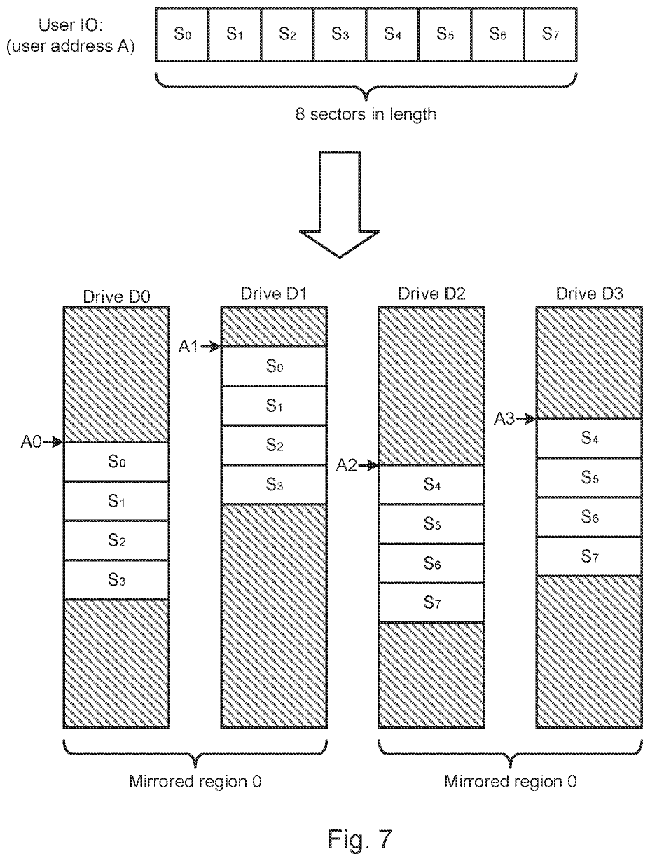

Following is an example of the use of one embodiment of a data storage system in accordance with the present disclosure. This example demonstrates a write IO in which the user designates a single drive redundancy with a desired access speed of 2 GB/s. The example is illustrated in FIG. 7.

Write IO

1. Volume V of the user is configured for a redundancy of 1 drive, and performance of 2 GB/s. It should be noted that performance may be determined in accordance with any suitable metric, such as throughput or latency. Read and write performance may be separately defined.

2. The user initiates a write IO to volume V, with address=A and length=8 sectors.

3. The storage system determines from the provided write IO information and the service level (redundancy and performance) information that data mirroring (the fastest RAID algorithm) is required to meet the performance objective.

4. The storage system determines that one drive can support 500 MB/s, so 4 drives are required in parallel to achieve the desired performance ([2 GB/s]/[500 MB/s per drive]=4 drives).

5. The storage system determines which 4 drives are to be used.
a. The storage system checks the drive backlog for all available drives.
b. The pending read and write counts are used to compute a load metric for each drive (e.g., the sum of the queue depths, or a weighted sum based on known drive properties).
c. Based on workload and IO size, one or more drives are excluded, and the 4 needed drives are selected from those remaining.
6. The storage system breaks the IO into 2 regions of 4 sectors each.

7. The storage system writes region 1 to drives 0 and 1, and region 2 to drives 2 and 3. This mirroring of each region achieves the 1 drive redundancy service level. The data stored on each of the drives may be stored at different offsets in each of the drives. It should also be noted that the write need not use all of the drives in the storage system—the four drives selected in this example for storage of the data may be only a subset of the available drives.

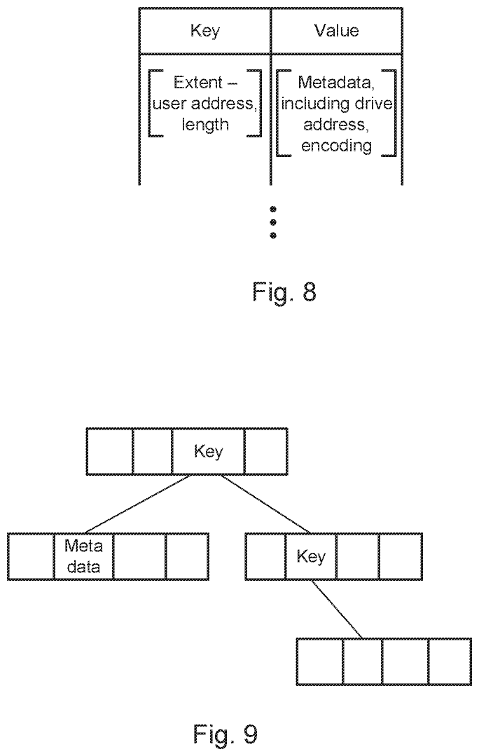

8. The storage system updates the metadata for user region address=A, length=8. The metadata includes the information: mirrored algorithm (RAID 0); length=4, drive D0 address A0 and drive D1 address A1; length=4, drive D2 address A2 and Drive D3 address A3. It should be noted that that drive addresses are allocated as needed, similar to a thin provisioning system, rather than allocating the same address on all of the drives. Referring to FIG. 8, the metadata may be stored in a table, tree or other data structure that contains key-value pairs, where the key is the extent (the user address and length of the data), and the value is the metadata (which defines the manner in which the data is encoded and stored on the drives). The keys will later be used to lookup the metadata, which will be used to decode and read the data stored on the drives.

9. The metadata is inserted into a key-value table (as referenced elsewhere) which is a data structure that uses a range of consecutive addresses as a key (e.g. address+length) and allows insert and lookup of any valid range. The implementation is unlikely to be a simple table—but rather a sorted data structure such as a B+TREE so that the metadata can be accessed for subsequent read operations. As noted above, the metadata In the example of FIG. 7, may be:

| | |
|---|---|
| Drive | address |

Region 0, mirror, length 4

| | |
|---|---|
| D0 | A0 |
| D1 | A1 |

Region 1, mirror, length 4

| | |
|---|---|
| D2 | A2 |
| D3 | A3 |

FIG. 9 illustrates a tree structure that can be used to store the keys and metadata values. As noted above, storing metadata in a data structure such as a tree structure is well-understood in file system design and will not be described in detail here. However, the specific features of the present embodiments such as the use of an extent (address, length) as a key, encoding the data according to a variable and selectable RAID technique and the storing the data on selectable drives at variable offsets, is not known in conventional storage systems.

10. If the user IO overwrote existing data, the metadata for the overwritten data is freed and the sectors used for this metadata are returned to the available capacity pool for later allocation.

11. If the user IO partially overwrote a previous write, the previous write may require re-encoding to split the region. This may be accomplished in several ways, including:
a. Rewriting the remaining portion of the previous IO with new encoding.
b. Rewriting just the metadata of the previous IO, indicating that a portion of the IO is no longer valid. (This is required for parity encodings.)
c. Updating the metadata of the previous IO, freeing unnecessary data sectors that were overwritten. (This is possible for mirrored encodings, as the old data is not required to rebuild the remaining portion of the IO.
d. Overwrites may be handled by a background garbage collection task, similar to NVME firmware controllers.

Following is an example of a read IO in one embodiment of a data storage system in accordance with the present disclosure. This example illustrates a read IO in which the user wishes to read 8 sectors of data from address A.

Read IO

1. User read IO with address=A, length=8 sectors from volume V.

2. The storage system performs a lookup of the metadata associated with the requested read data. The metadata lookup may return 1 or more pieces of metadata, depending on the size of the user writes according to which the data was stored. (There is 1 metadata entry per write in this embodiment.)

3. Based on the metadata, the software determines how to read the data to achieve the desired data rate. The data may, for example, need to be read from multiple drives in parallel if the requested data throughput is greater than the throughput achievable with a single drive.

4. The data is read from one or more drives according to the metadata retrieved in the lookup. This may involve reading multiple drives to get the requested sectors, and may involve reading from the drives in parallel in order to achieve the desired throughput. If one of the drives has failed, the read process recognizes the failure and either selects a non-failed drive from which the data can be read, or reconstructs the data from the one or more of the non-failed drives.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more I/O device(s). The I/O devices can include a keyboard, monitor, printer, electronic pointing device (such as a mouse, trackball, stylus, etc.), or the like. In various embodiments, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example”, “for instance”, “e.g.”, “in one embodiment”.

In the foregoing specification, the invention has been described with reference to specific embodiments. However, one of ordinary skill in the art appreciates that various modifications and changes can be made without departing from the scope of the invention as set forth. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for RAID storage of data, the system comprising:
a plurality of storage drives; and
a storage engine coupled to the storage drives;
wherein the storage engine is configured to receive from a user a plurality of write requests to write data on one or more of the plurality of storage drives;
wherein for each of one or more of the plurality of write requests, the storage engine is configured to
determine a corresponding RAID encoding;
determine a number, M, of the plurality of storage drives required for the corresponding RAID encoding, wherein the number is less than a total number, N, of the plurality of storage drives;
determine expected performance for one or more of the plurality of storage drives;
select a set of storage drives including M of the plurality of storage drives based at least in part on the expected performance for the plurality of storage drives
write corresponding data to the selected set of M storage drives using the corresponding RAID encoding.

2. The system of claim 1, wherein the storage engine is configured to:
determine the expected performance by determining a queue depth for each of the N storage drives; and
select the set of M storage drives by excluding one or more of the storage drives which have a lowest expected performance of the N storage drives and selecting the set of M storage drives from a remainder of the storage drives.

3. The system of claim 2, wherein the queue depth for each of the plurality of storage drives comprises a sum of a number of pending reads and a number of pending writes.

4. The system of claim 2, wherein the queue depth for each of the plurality of storage drives comprises a sum of a weighted number of pending reads and a weighted number of pending writes.

5. The system of claim 2, wherein a first one of the one or more of the plurality of write requests is written to a first set of M storage drives and a second one of the one or more of the plurality of write requests is written to a second set of M storage drives which is different from the first set of M storage drives.

6. The system of claim 1, wherein the storage engine is further configured to determine the RAID encoding corresponding to each write request based at least in part on a service level indicated by the user, wherein the service level includes a redundancy level.

7. The system of claim 1, wherein the storage engine is further configured to determine the RAID encoding corresponding to each write request based at least in part on a service level indicated by the user, wherein the service level includes a data access speed.

8. The system of claim 1, wherein the storage engine is configured to maintain a metadata tree, wherein for each write request, the metadata tree includes a corresponding entry wherein a key of the entry comprises the user address and a value of the entry comprises the one or more corresponding physical addresses.

9. The system of claim 8, wherein for each write request, the key of the corresponding entry further comprises a data length, and the value of the corresponding entry further comprises the RAID encoding.

10. A system for RAID storage of data, the system comprising:
a plurality of storage drives; and
a storage engine coupled to the storage drives;
wherein the storage engine is configured to receive from a user a plurality of write requests to write data on one or more of the plurality of storage drives;
wherein for each of one or more of the plurality of write requests, the storage engine is configured to
determine an expected performance for each of the plurality of storage drives;
determine a number, M, of the plurality of storage drives that have expected performance which have an acceptable level of expected performance, wherein M is less than a total number, N, of the storage drives;
determine, based at least in part on the number, M, of the plurality of storage drives, a corresponding RAID encoding;
select a set of storage drives including M of the plurality of storage drives having the acceptable level of expected performance based at least in part on the corresponding RAID encoding
write corresponding data to the one or more selected storage drives using the corresponding RAID encoding.

11. The system of claim 11, wherein the storage engine is configured to determine the expected performance by:
determining a queue depth for each of the N storage drives, the queue depth comprising a sum of a weighted number of pending reads and a weighted number of pending writes; and
select the set of M storage drives by excluding one or more of the storage drives which have a lowest expected performance of the N storage drives and selecting the set of M storage drives from a remainder of the storage drives.

12. The system of claim 10, wherein the storage engine is further configured to determine the RAID encoding corresponding to each write request based at least in part on a service level indicated by the user, wherein the service level includes a data access speed.

13. The system of claim 10, wherein the storage engine is configured to maintain a metadata tree, wherein for each write request, the metadata tree includes a corresponding entry wherein a key of the entry comprises the user address and a data length, and wherein a value of the entry comprises the one or more corresponding physical addresses on the selected set of M storage drives and the RAID encoding.

14. A method for RAID storage of data, the method comprising:
in a data storage system having a plurality of storage drives,
receiving one or more write requests to write data on one or more of the plurality of storage drives; and
for each of one or more of the one or more write requests,
determining a corresponding RAID encoding;
determining a number, M, of the plurality of storage drives required for the corresponding RAID encoding, wherein the number is less than a total number, N, of the plurality of storage drives;
determining expected performance for one or more of the plurality of storage drives;
selecting a set of storage drives including M of the plurality of storage drives based at least in part on the expected performance for the plurality of storage drives
writing corresponding data to the selected set of M storage drives using the corresponding RAID encoding.

15. The method of claim 14, wherein
determining the expected performance comprises determining a queue depth for each of the N storage drives; and
selecting the set of M storage drives comprises excluding one or more of the storage drives which have a lowest expected performance of the N storage drives and selecting the set of M storage drives from a remainder of the storage drives.

16. The method of claim 15, wherein the queue depth for each of the plurality of storage drives comprises a sum of a weighted number of pending reads and a weighted number of pending writes.

17. The method of claim 15, wherein a first one of the one or more of the plurality of write requests is written to a first set of M storage drives and a second one of the one or more of the plurality of write requests is written to a second set of M storage drives which is different from the first set of M storage drives.

18. The method of claim 14, further comprising determining the RAID encoding corresponding to each write request based at least in part on a service level indicated by the user, wherein the service level includes a redundancy level.

19. The method of claim 14, further comprising determining the RAID encoding corresponding to each write request based at least in part on a service level indicated by the user, wherein the service level includes a data access speed.

20. The method of claim 14, further comprising maintaining a metadata tree, wherein for each write request, the metadata tree includes a corresponding entry wherein a key of the entry comprises the user address and a data length, and wherein a value of the entry comprises the one or more corresponding physical addresses on the selected set of M storage drives and the RAID encoding.
